(19) United States
(12) Patent Application Publication
(10) Pub. No.: US 2015/0109331 A1
(43) Pub. Date: Apr. 23, 2015

(54) SYSTEM AND METHOD FOR SUPERIMPOSING AN OPTICAL READABLE DATA MATRIX CODE ON AN IMAGE

(71) Applicant: Eyeconit Ltd., Herzliya (IL)

(72) Inventors: Itamar Friedman, Israel (IL); Nevo Alva, Karmey Josef (IL); Uriel Peled, Kibbutz Ramat Yohanan (IL)

(73) Assignee: Eyeconit Ltd.

(21) Appl. No.: 14/402,508

(22) PCT Filed: Feb. 4, 2013
(86) PCT No.: PCT/IL2013/050101

§ 371 Date: Nov. 20, 2014

Related U.S. Application Data
(60) Provisional application No. 61/656,307, filed on Jun. 6, 2012.

(51) Int. Cl. G06T 11/60

(52) U.S. Cl. CPC G06T 11/60
USPC 345/629

(57) ABSTRACT

According to examples of the presently disclosed subject matter, a process for superimposing a matrix code on an image can include: (a) superimposing a frame on the image; (b) superimposing the matrix code on the image within the frame and providing a superimposition image; (c) moving the frame on the superimposition image in accordance with the command; and (d) repeating operations (a), (b) and (c) as required.

### TECHNOLOGICAL FIELD

This invention relates to optical readable data matrix codes and involves image processing and computer vision techniques.

### BACKGROUND

U.S. Pat. No. 8,144,922 to Kawabe et al discloses a method in which a two-dimensional code that represents information by means of a cell dot distribution pattern, formed by having a plurality of colored cells and a logo mark, are superimposed.

US Patent Publication 200910255992 to Shen discloses a system for synthesizing a two dimensional code and a logo. At least a part of the logo is overlapped with the two dimensional code. If the two dimensional code has a code error rate larger than an error correction rate, the size of the logo and/or the location of the logo is adjusted with respect to the two dimensional code.

US Patent Publication 2009/0057420 to Onoda et at discloses two-dimensional code merged with an image. Base cells and data cells in the two-dimensional code are arranged in a matrix, and either the base cells or the data cells are clear. The clear two-dimensional code can be read only when a color shown on the clear cells consisting of either the base cells or the data cells and a color shown on non-clear cells consisting of either the base cells or the data cells have a contrast which can be read by a code recognition apparatus.

### GENERAL DESCRIPTION

Many of the functional components of the presently disclosed subject matter can be implemented in various forms, for example, as hardware circuits comprising custom VLSI circuits or gate arrays, or the like, as programmable hardware devices such as FPGAs or the like, or as a software program code stored on an intangible computer readable medium and executable by various processors, and any combination thereof. A specific component of the presently disclosed subject matter can be formed by one particular segment of software code, or by a plurality of segments, which can be joined together and collectively act or behave according to the presently disclosed limitations attributed to the respective component. For example, the component can be distributed over several code segments such as objects, procedures, and functions, and can originate from several programs or program files which operate in conjunction to provide the presently disclosed component.

In a similar manner, a presently disclosed component(s) can be embodied in operational data or operational data can be used by a presently disclosed component(s). By way of example, such operational data can be stored on a tangible computer readable medium. The operational data can be a single data set, or can be an aggregation of data stored at different locations, on different network nodes or on different storage devices.

The present invention provides a process and system for superimposing a matrix code such as a QR Code, or an EZcode, on an image.

According to an aspect of the presently disclosed subject matter, there is provided a system for superimposing a matrix code on an image. According to examples of the presently disclosed subject matter, the system for superimposing a matrix code on an image can include a processor having an associated memory and one or more input devices. The processor can be configured to execute processes comprising:
a. superimposing a frame on the image;
b. superimposing the matrix code on the image within the frame and providing a superimposition image;
c. receiving a command to move the frame on the superimposition image, and moving the frame on the superimposition image in accordance with the command; and
d. repeating operations (a), (b) and (c) as required.

According to examples of the presently disclosed subject matter, superimposing the matrix code on the image can include forming a linear combination of at least a portion of the matrix code, or part of it, and at least a portion of the image inside the frame.

Further by way of example, superimposing the matrix code on the image can include making cells in the matrix code transparent or translucent.

Still further by way of example, the processor can be further configured to edit the superimposition image.

Yet further by way of example, editing can include cropping the image around the frame.

In yet further examples, editing can include re-superimposing the matrix code on the image using a different method of superimposition.

In still further examples, the operation referenced (b) above can be performed using a light run-time superimposing technique, and re-superimposing the matrix code on the image can be performed using a heavy run-time technique.

In still further examples of the presently disclosed subject matter, the processor can be configured to store a result of the process in the memory.

According to some examples, the process further includes zooming in on any part of the superimposition image.

According to examples of the presently disclosed subject matter, the processor can be further configured to execute software to position the frame on the superimposition image.

In still further examples of the presently disclosed subject matter, the processor can be further configured to receive an input indicative of the superimposition being satisfactory.

In still further examples, the input indicative of the superimposition being satisfactory can be input by one or more of the input devices.

According to examples of the presently disclosed subject matter, the command to move the frame can be input to the processor using an input device that is different from the input device used to input an indication that the superimposition is satisfactory.

In still further examples, the process can include changing the matrix code when the frame is moved in the superimposition image.

According to examples of the presently disclosed subject matter, the processor can be remotely located from the input devices.

According to examples of the presently disclosed subject matter, superimposition of the matrix code on the image can include altering translucent properties of the matrix code to produce a matrix code having altered translucent properties, and the processor can be further configured to save in a memory the matrix code having altered translucent properties.

According to a further aspect of the presently disclosed subject matter, there is provided a process for superimposing a matrix code on an image. According to examples of the presently disclosed subject matter, the process for superimposing a matrix code on an image can include:
a. superimposing a frame on the image;
b. superimposing the matrix code on the image within the frame and providing a superimposition image;
c. moving the frame on the superimposition image in accordance with the command; and
d. repeating operations (a), (b) and (c) as required.

By way of example, superimposing the matrix code on the image involves forming a linear combination of at least a portion of the matrix code, or part of it, and at least a portion of the image inside the frame.

Further by way of example, superimposing the matrix code on the image involves making cells in the matrix code transparent or translucent.

Still further by way of example, the process can include editing the superimposition of the matrix code and the image.

According to examples of the presently disclosed subject matter, the editing can include cropping the image around the frame.

Still according to examples of the presently disclosed subject matter, the editing can include re-superimposing the matrix code on the image using a different method of superimposition.

According to examples of the presently disclosed subject matter, the operation referenced (b) above can be performed using a light run-time superimposing technique, and re-superimposing the matrix code on the image is performed using a heavy run-time technique.

In still further examples of the presently disclosed subject matter, the process can include zooming in on any part of the superimposition image.

According to examples of the presently disclosed subject matter, superimposition of the matrix code on the image can include altering translucent properties of the matrix code to produce a matrix code having altered translucent properties, and saving to memory the matrix code having altered translucent properties.

According to yet another aspect of the presently disclosed subject matter, there is provided a program storage device readable by machine, tangibly embodying a program of instructions executable by the machine to perform a method of superimposing a matrix code on an image. According to examples of the presently disclosed subject matter, the program storage device readable by machine, tangibly embodying a program of instructions executable by the machine to perform a method of superimposing a matrix code on an image can include:
a. superimposing a frame on the image;
b. superimposing the matrix code on the image within the frame and providing a superimposition image;
c. moving the frame on the superimposition image in accordance with the command; and
d. repeating operations (a), (b) and (c) as required.

According to yet another aspect of the presently disclosed subject matter, there is provided a computer program product comprising a computer useable medium having computer readable program code embodied therein of superimposing a matrix code on an image. According to examples of the presently disclosed subject matter, the computer program product comprising a computer useable medium having computer readable program code embodied therein of superimposing a matrix code on an image can include:
a. computer readable program code for causing the computer to superimpose a frame on the image;
b. computer readable program code for causing the computer to superimpose the matrix code on the image within the frame and providing a superimposition image;
c. computer readable program code for causing the computer to move the frame on the superimposition image in accordance with the command; and
d. computer readable program code for causing the computer to repeat the computer readable code (a), (b) and (c) as required.

In a process according to examples of the presently disclosed subject matter, the image can be displayed on a display screen. A position indicator, such as a frame having the shape of the contour of the matrix code, can be displayed on the display screen superimposed on the image. By way of example, the position of the frame on the screen and the size of the frame can be manually selected by a user using various input devices. The matrix code can be inserted into the frame superimposed on the portion of the image contained in the frame. In some examples, any type of superimposition can be used. For example, the superimposition can be a linear combination of the matrix code and the image in the frame. As another example, cells of specific colors in the matrix code could be made to be transparent or translucent prior to superimposing the matrix code on the image in the frame. In this case, a portion of the image is visible in the frame under the transparent squares of the matrix code. In the above example the entire or a fraction of each cell can be made transparent or translucent.

It is then determined whether the superimposition of the matrix code and the image is satisfactory. The superimposition may not be satisfactory, for example, if too many details in the image are obscured or blurred by cells of the matrix code, or if a particularly significant part of the image is obscured or blurred by cells of the matrix code. The superimposition can be evaluated by a user (e.g. visually), or using some predefined criterion and algorithms, e.g. for evaluating blurriness, etc.

If the superimposition is not satisfactory, and in response to an instruction from a user, or in response to evaluation of the superimposition failing to meet a criterion, the frame is repositioned on the display screen and the matrix code is superimposed on the image at the new location of the frame. The position of the frame can be manually selected by the user, or can be selected or proposed based on a predefined algorithm. The frame may be repositioned any number of times on the display screen until a satisfactory superimposition is found.

When a satisfactory superimposition of the matrix code and the image is found, the superimposition can be edited. A satisfactory result can be when a user indicates that the superimposition is satisfactory (e.g. based on visual inspection), or when a certain criterion is met. The result can be stored in a memory. Along or at the end of the process, the image or the matrix code can be edited or changed. For example the image can be cropped around the satisfactory frame. In another example, the image can be cropped in order to fit the screen size. As another example, the superimposing process, or part of it, can be changed for every position of the frame. As part of this change, the matrix code itself can be changed to most fit the image on the new position considering perceptual similarity measures.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 shows a system for superimposing a matrix code on an image, in accordance with examples of an aspect of the presently disclosed subject matter;

FIG. 2 shows a flow chart of a process for superimposing a matrix code on an image, in accordance with examples of an aspect of the presently disclosed subject matter;

FIG. 3a-3f show six screen shots displayed on a display screen and collectively illustrate certain features of the process of FIG. 2 being executed;

FIG. 4 shows a system for superimposing a matrix code on an image, in accordance with examples of an aspect of the presently disclosed subject matter;

FIGS. 5a-5f show a few position indicators, in accordance with examples of an aspect of the presently disclosed subject matter, and

FIG. 6 shows a flow chart of a process for superimposing a matrix code on an image, in accordance with examples of an aspect of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

In the following detailed description, numerous specific details are set forth in order to provide a thorough understanding of the presently disclosed subject matter. However, it will be understood by those skilled in the art that the presently disclosed subject matter may be practiced without some of these specific details. In other instances, well-known methods, procedures and components have not been described in detail so as not to obscure the presently disclosed subject matter.

Unless specifically stated otherwise, as apparent from the following discussions, it is appreciated that throughout the specification various functional tenns refer to the action and/or processes of a computer or computing device, or similar electronic computing device, that manipulate and/or transform data represented as physical, such as electronic, quantities within the computing device's registers and/or memories into other data similarly represented as physical quantities within the computing device's memories, registers or other such tangible information storage, transmission or display devices.

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

As used herein, the terms “example”, “for example,” “such as”. “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

The references cited in the background teach many principles of measuring a body part that are applicable to the presently disclosed subject matter. Therefore the full contents of these publications are incorporated by reference herein where appropriate for appropriate teachings of additional or alternative details, features and/or technical background.

The operations in accordance with the teachings herein may be performed by a computer specially constructed for the desired purposes or by a general purpose computer specially configured for the desired purpose by a computer program stored in a non-transitory computer readable storage medium.

Embodiments of the presently disclosed subject matter are not described with reference to any particular programming language. It will be appreciated that a variety of programming languages may be used to implement the teachings of the presently disclosed subject matter as described herein.

Unless specifically stated otherwise, as apparent from the following discussions, it is appreciated that throughout the specification discussions utilizing terms such as “processing”, “calculating”, “computing”, “obtaining”, “utilizing”, “adjusting”, “determining”, “generating”, “setting”, “configuring”, “selecting”, “measuring”, “searching”, “evaluating”, “displaying”, “communicating”, “receiving”, “storing” or the like, include actions and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a Smartphone or other handheld device that includes or is associated with sensors capable of measuring a displacement of the Smartphone at least along a body part of a user (or any other person), etc. The term “optical readable data matrix code” or “matrix code” is used herein to refer to two dimensional code of a cell dot distribution pattern that is used to encode data. Each cell has a value selected from a predetermined set of values defined in the matrix code specification. Upon detection and decoding of the matrix code, the decoded value of each cell is calculated as a function of the color/hues of the pixels representing the cell. A matrix code is typically detected as a 2-dimensional digital image by a two-dimensional image detector and is then digitally analyzed and decoded by a programmed processor. In the decoding process the cells are converted to values and validity checked and interpreted with an error-correcting code. Finally they are translated from a set of values to the encoded data.

Different matrix code types are associated with a different respective matrix code specification. The term matrix code specification is known in the art of optical machine-readable coding, and the following definition is provided as a non-limiting example only for convenience purposes. Accordingly, the interpretation of the term matrix code specification in the claims, unless stated otherwise, is not limited to the definitions below and the term should be given its broadest reasonable interpretation. The term matrix code specification as used herein relates to a framework of specifications which collectively define various aspects relating to the visual appearance of an object that has some code that is visually encoded in the object in the form of a visual matrix code. By way of example, a matrix code specification can include some or all of the following: a general matrix specification, a basic cell specification, a function (such as finder) patterns specification, a code word area specification and information cells specification.

As explained above, a matrix code specification is a framework of specifications which collectively define various aspects relating to the visual appearance of an object that has some code that is visually encoded in the object in the form of a visual matrix code. In some matrix code specifications, a framework of reading and decoding methods are also suggested. Based on a given matrix code specification and the suggested reading and decoding framework, a compatible decoder can be designed and operated to allow reading and decoding of visual objects that include matrix code.

It should be noted that some matrix coding specifications include tolerances or variations and allow for the appearance of the cells and/or of the two-dimensional patterns to have different appearances or to shift within a certain range without rendering the matrix code unreadable. For example, some types of matrix code specifications can include: different coding modes, different masks, reflectance reversal, mirror imaging etc., and a message can be associated with different matrix code representations, for example according to the different modes, masks, etc., and each of the different representations can be compatible with the matrix code specification. It would be appreciated that throughout the present disclosure and in the claims, the term tolerance encompasses also a negative tolerance which can be effective for limiting a certain range of values which is suggested or required for cells or patterns that are part of a matrix code.

Furthermore, it should be noted, that some scanners, imagers, readers and/or decoders allow certain tolerances and/or deviations from the matrix code specification, as will be further explained below.

Accordingly, in some examples of the presently disclosed subject matter, the term matrix code can refer to a visual object that is compatible with a respective matrix code specification, and in further examples of the presently disclosed subject matter, the term matrix code can be a representation of a visual object that is readable according to a certain matrix code specification that is configured, adapted or adjusted in accordance with the specific characteristics of a given scanner, reader or decoder or any combinations thereof, or even to a general characteristic of scanners, readers or decoders. In the latter case, the readability or eligibility of the matrix code is determined according to the ability, possibly the de-facto ability, of a certain decoding device or devices to decode a given matrix code representation that is generated based on a given matrix code specification and the tolerances and/or deviations that are supported or corrected by the decoding device or devices.

One common matrix code is the QR (Quick Response) Code. QR Code is a registered trademark of Denso Wave. A QR Code consists of an array of dark cells and light cells arranged in a square pattern. The information encoded can be made up of four standardized kinds (“modes”) of data (numeric, alphanumeric, byte/binary, Kanji), or through supported extensions, virtually any kind of data. In order to detect and decode the QR Code, the processor locates at least three distinctive patterns, known as finder patterns, and can normalize image size, orientation, and angle of viewing. Other functional patterns, such as the alignment and timing patterns, enhance this process.

The QR Code specification (used here as an example of a matrix code specification) defines the color values of cells as dark and light. By way of example, a QR Code scanner, that is a matrix code scanner that is configured to detect and decode matrix codes that are compatible with the QR Code specification, can convert an image which includes dark and light colors which represent a matrix code to a set of dark and light pixels using a global threshold, and thus the colored image provides a matrix code. By way of example, the global threshold that is implemented by the QR CodeScanner can be determined by taking a reflectance value midway between the maximum reflectance and minimum reflectance in the image. This means that an image which represents a matrix code, according to examples of the presently disclosed subject matter, can have a wide range of color choices for areas which represent matrix code cells for which the matrix code specification suggests a light or a dark value.

In this sense, according to examples of the presently disclosed subject matter, a matrix code can be considered to be a readable matrix code, even when the colors that are used in the matrix code or in the image which represents the matrix code are not explicitly, in and of themselves, compatible with the corresponding matrix code specification, but are such that when read and processed by the reader/decoder, the resulting color values are compatible with the matrix code specification. In such cases, the colors that are used in the matrix code or in the image which represents the matrix code can be based on the matrix code specification, but additional processing can be applied to take advantage, inter-alia, of the tolerances, characteristics, configurations and/or capabilities of the decoders, scanners or imagers, (or any other equipment that is used to process an image and decode a matrix code), such that the values that are calculated for the matrix code provide a certain level (e.g., the highest possible) of visual perceptual similarity to respective areas of an input image, while meeting, de-facto, following imaging, scanning, processing, etc. the requirements of the matrix code specification.

Another common matrix code is the EZcode created by ETH Zurich and exclusively licensed to Scanbuy in 2006. A typical EZCode consists of a 2-dimensional 11×11 array of cells (large dark or light pixels) arranged in a grid. The typical EZcode has a storage capacity of 76 bits. In order to detect pixel errors and false orientation features, the code bits are protected by an (83,76,3) linear code that generates an 83-bit code word from a 76-bit value and has a Hamming distance of 3. Typically, the data that is stored in the EZcode is mainly used as a key to a central database owned by Scanbuy.

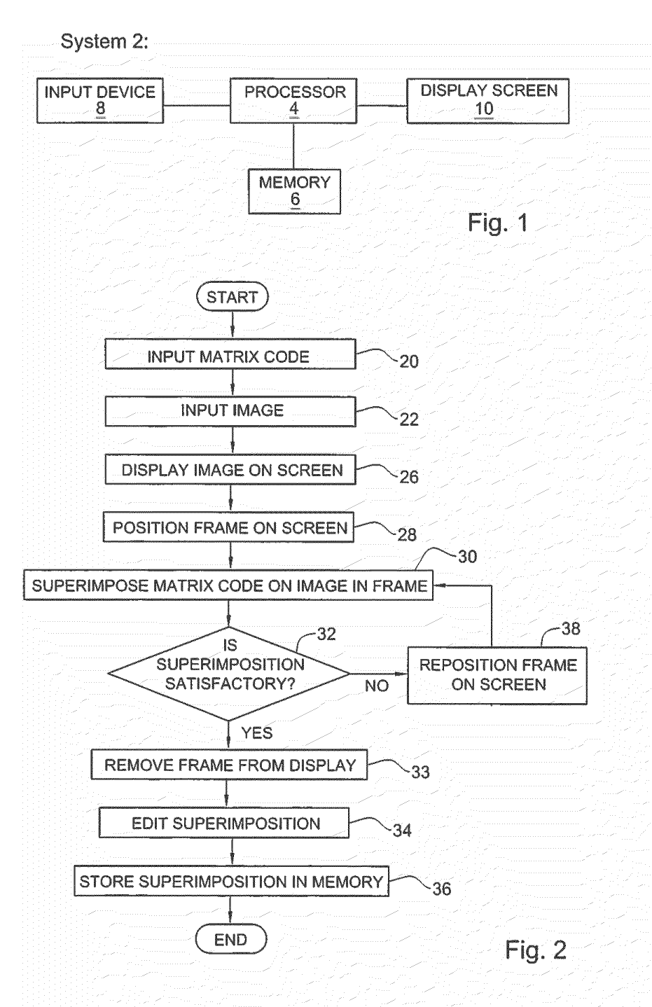

FIG. 1 shows a system 2 for superimposing a matrix code on an image, in accordance with aspects of the presently disclosed subject matter. The system 2 comprises a processor 4 having an associated memory 6. An input device 8, such as a computer mouse, and/or keyboard, and/or touch-screen can be used to input data to the processor 4. Further by way of example, a display screen 10, such as a LCD screen can be used to display images to a user, as explained below.

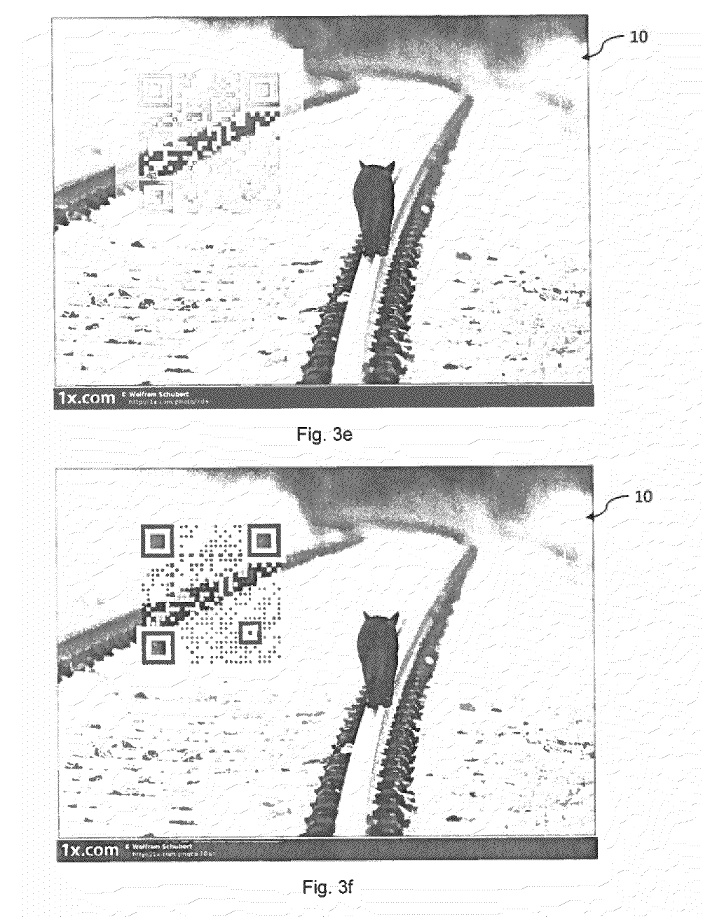

FIG. 4 shows a system 3 for superimposing a matrix code on an image, in accordance with further examples of the presently disclosed subject matter. System 3 resembles system 2 but further comprises a processor 5 having an associated memory 7 on a remote device. It should be appreciated that any functionality held by processor 4 in system 2 can be implemented by processor 4 and/or processor 5 in system 3. It should also be appreciated that any functionality held by memory 6 in system 2 can be done by memory 6 and/or memory 7 in system 3. In other examples, the system is a distributed system which includes processing and other resources on a plurality of computers.

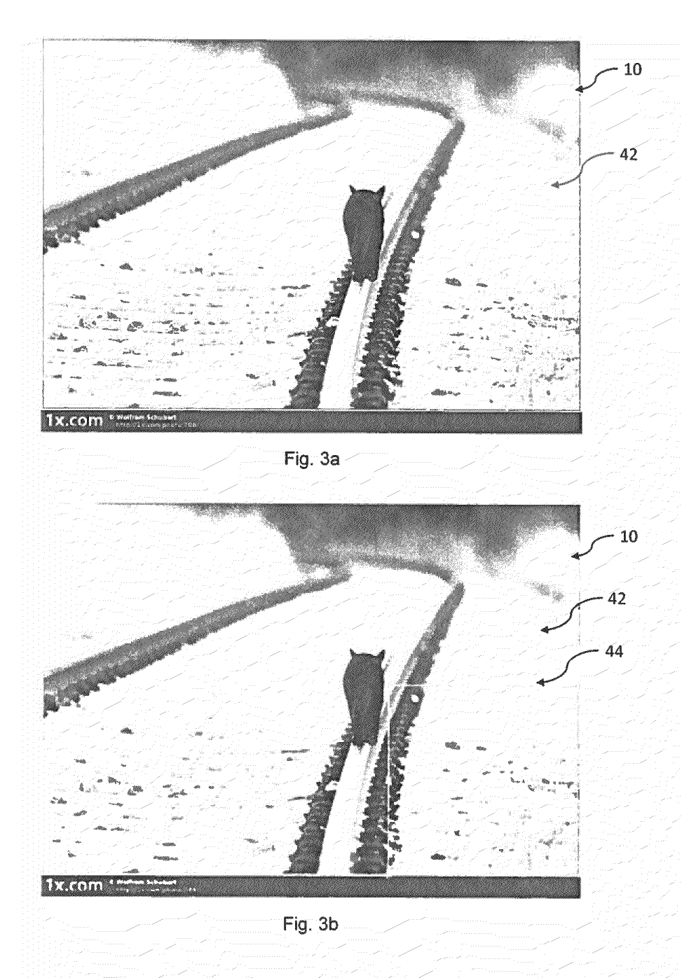

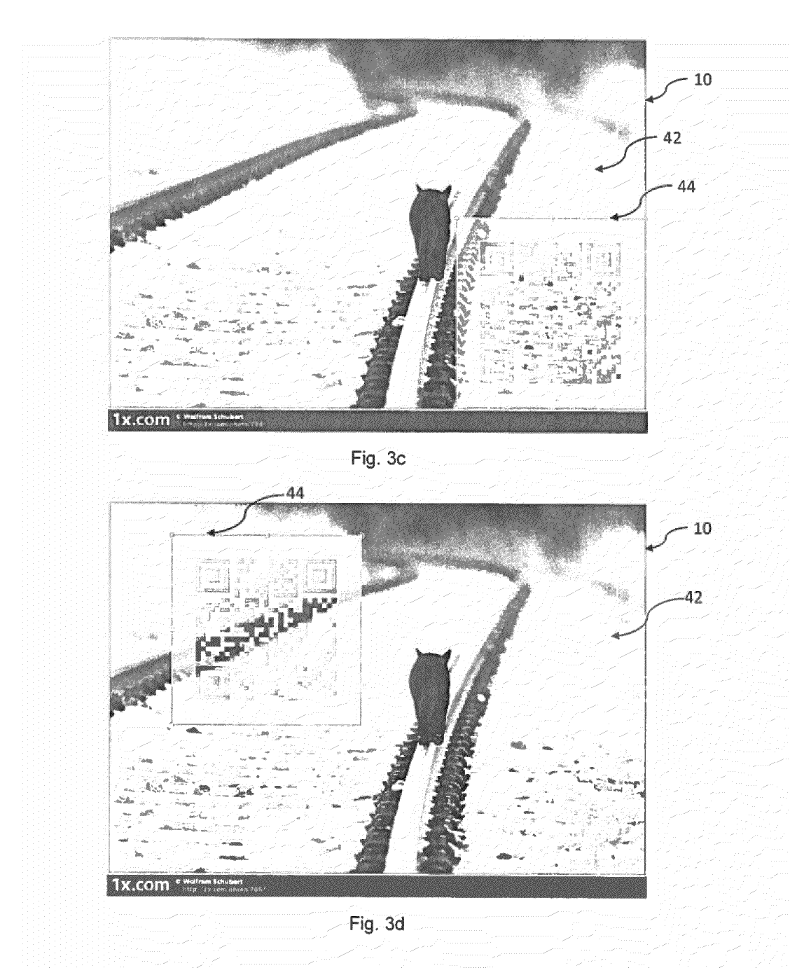

FIG. 2 shows a flow chart of a method for superimposing a matrix code on an image in accordance with examples of an aspect of the presently disclosed subject matter. FIGS. 3a-3f FIG. 3a-3f show six screen shots displayed on a display screen 10 and collectively illustrate certain features of the process of FIG. 2 being executed. In block 20 a matrix code is stored in the memory 6 of the system 2, and in block 22 an image is stored in the memory 6. The matrix code consists of a 2D array of cells, where each cell has a color value selected from a predetermined set of color values. It should be appreciated that the matrix code and the image can be presented in various forms including, but not limited to: digital representation of a two-dimensional figure, such as a paint, photograph, map, chart, draw or print. It should also be appreciated that the matrix code may also be presented as a set of matrix code specification's settings and parameters.

Then, in block 26, the image 42 input in block 22 is displayed on the display screen 10 as shown in FIG. 3a. It should be appreciated that the image 42 which is displayed on the display screen 10 can be the image stored in memory 4 or a modification of the stored image. This modification can include, but is not limited to: cropping, rotating, brightening, adding an alpha channel, blurring and adding special effects. For example, the image may be cropped to best fit the display screen 10. In another example, the image can be rotated to fit the orientation of the display screen 10 in case the display screen is part of a handheld device. And yet in another example, the image can be adjusted with special effects in order to be displayed on a social media that is known to apply effects on images.

In block 28, a position indication is presented to the user on the display screen 10. The indication should illustrate the location where the matrix code will be superimposed in block 30. Such indicator may be a frame 44 having the shape of the contour of the matrix code, superimposed on the image 42 (FIG. 3b). The position of the frame 44 on the screen and the size of the frame can be selected by a user using the input device 8. In another example, the method can include determining the position of the frame 44 according to a predefined criterion. Optionally, the position that was selected according to the predefined criterion can be presented to the user as a suggested position, and the user can adjust or change the selected position. Further by way of example, the predefined criterion for selecting the position of the frame can include saliency detection. The use of the saliency detection method for selecting the position of the frame is further discussed below.

It should be appreciated that the indication can vary in its shape, color and pattern as long as the user can deduce the position on which the matrix code will be superimposed. For example, frame 44 is an outline of a rectangle which indicates the borders of a certain matrix code.

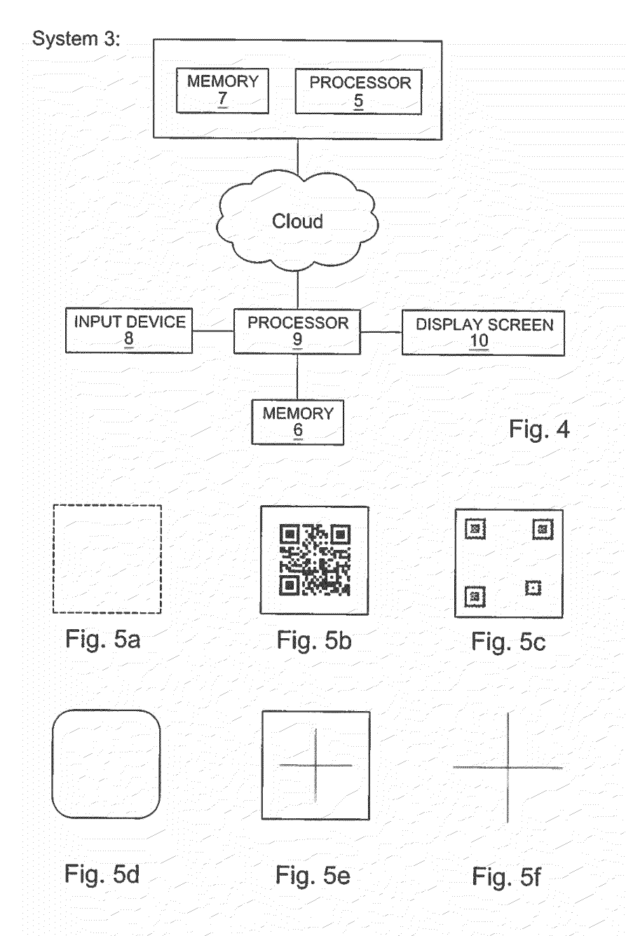

FIGS. 5a-5f show six examples of possible position indicators that can be presented in block 28 on the display screen 10. FIG. 5a shows an outline of a rectangle which indicates the borders of a matrix code. FIG. 5b shows a partly transparent matrix code demo and its outline. FIG. 5c shows an outline of a rectangle which indicates the borders of a matrix code and a few cells of the matrix code. An example for such models can be the models that are similar in all the instances of a specific matrix code type. FIG. 5d shows an outline of a rounded rectangle which indicates the borders of a matrix code and a partly transparent layer. FIG. 5e shows an outline of a rectangle which indicates the borders of a matrix code, and a crosshair. FIG. 5f shows a crosshair that approximately or precisely indicates the center of a matrix code.

The matrix code that was input to the system 2 in block 22 is in block 30 superimposed on the image in the frame (FIG. 3c). Any method for superimposing two images may be used. For example, the superimposition may be a translucent linear combination of the matrix code and the portion of the image in the frame. As another example, cells in the matrix code having specific colors may be made transparent.

In some examples of the presently disclosed subject matter the user can be given the option to select between a few superimposing techniques or parameters. These options can be presented on the display screen 10. In zero, one or more superimposing process occurrences, such as in block 30, the user will be able to choose a preferred superimposing technique from at least two superimposing techniques using the input device 8. A few of such superimposing techniques will be further described below.

By way of example, at any time, the user may zoom out or zoom in on any part of the image 42, and in particular, on the portion of the image 42 within the frame 44.

In block 32, it is determined whether the superimposition of the matrix code and the image is satisfactory. The superimposition may not be satisfactory, for example, if too many details in the image are obscured or blurred by cells in the matrix code, or if a particularly significant part of the image is obscured or blurred by the cells of the matrix code, or for any other reason determined by the user. The evaluation of the quality of the superimposition and the determination whether the image is satisfactory or not can be visually estimated by the user, as indicated by an input (or lack thereof) from the user, or, in another example, one or more image processing algorithms can be employed to evaluate predefined characteristics of the image, and predefined criteria can be used to determine whether the resulting image is satisfactory or not.

If in block 32 it is determined that the superimposition is not satisfactory, the process can proceed to block 38 where the frame is moved on the display screen e.g. using the input device 8, and the process returns to block 30 where the matrix code is superimposed on the image 42 at the new location of the frame (FIG. 3d). As mentioned above, the location of the frame can be determined or suggested by an algorithm which employs image processing and predefined criteria to select a position(s) of the frame.

If in block 32 it is determined that the superimposition of the matrix code and the image is satisfactory, then in block 33 the frame 44 may be removed from the display (FIG. 3e). The superimposition may be edited. Editing of the image may involve, for example, cropping the image around the frame or at any other desired position. As another example, editing the image may involve changing the method of superimposition (FIG. 3f).

In another example, a different superimposing technique can be used in different blocks such as using a light run-time superimposing technique in block 30 and a heavy run-time technique in the editing block 34. A light run-time superimposing technique can typically require a few, or a relatively small number of calculations per pixel, and a heavy run-time technique might require, relatively, many calculations per pixel. An example of a light run-time superimposing technique is a simple linear combination of a matrix code image and the image 42. An example of a heavy run-time superimposing technique can be a technique that utilizes computer-vision methods. Such a heavy run-time superimposing technique will be further discussed below.

The result may be stored in the memory 6. It should be appreciated that the resulting image can be presented in various forms including, but not limited to: digital representation of a two-dimensional figure, such as a pixel image format, vector graphics format, chart or drawing.

In some embodiments of the invention, a sub-process is used to carry out one or additional operations held in blocks 28 and 38. The sub-operation can be, for example, an automatic operation in which additional software or program threads suggest a position of the frame.

In other embodiments, different input devices 8 are used for different types of input. For example, the decision at block 32 can be input by one input device, while the position commands 28 and 38 can be input by a second input device.

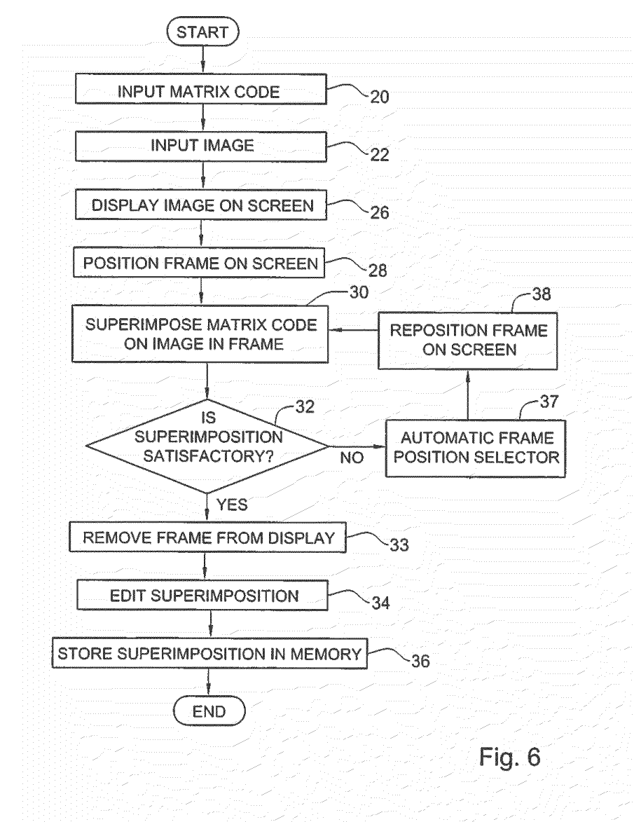

As shown in FIG. 6, in some examples of the presently disclosed subject matter, computer-vision methods can be used to facilitate the position selection. These methods may involve, for example, saliency detection, face detection and object detection. For example an initial position for the position indicator can be suggested in block 27.

An example of a computer-vision method which can be utilized in order to facilitate the position selection according to examples of the presently disclosed subject matter is now described. A face detector method, such as the known “Viola&Jones” (see for example: Rapid Object Detection Using A Boosted Cascade of Simple Features, http://research.microsoft.com/en-us/um/people/viola/Pubs/Detect/violaJones_CVPR2001.pdf, which is hereby incorporated by reference in its entirety) face detector algorithm, can be used to detect faces in the input image on block 27. The position indicator can then be positioned automatically, as an initial suggestion on block 28, either on the detected face or not. It should be appreciated that the described above can be utilized also on blocks 37 and 38 respectively. For example, an input image for which more than one face was detected, frame 44 can be initially positioned on a certain face on block 28, and then can be initially positioned on another face on block 38. A position algorithm can also be used, by way of example, to exclude an area of the image as a candidate for the superimposition frame location.

Another example of a computer-vision method which can be utilized in order to facilitate the position selection according to examples of the presently disclosed subject matter is now described. A saliency detection method, such as the known “Global Contrast based Salient Region Detection” saliency detector or the “Context-aware saliency detection” algorithm, can be used to find salient objects and/or areas on the input image prior to block 27. The position indicator can then be positioned automatically, as an initial suggestion on block 28, either on the salient area/object or not. It should be appreciated that the described above can be utilized also on blocks 37 and 38, where block 37 can operate similarly to block 27 and block 38 can operate similarly to block 28. For example, in an input image for which more than one salient area or object was detected, frame 44 can be initially positioned on a certain area/object in block 28, and then can be initially positioned on another area/object in block 38.

A superimposing technique can be utilized in block 30, and possibly in block 34, in order to superimpose a matrix code on an image. An example of a superimposing technique according to examples of the presently disclosed subject matter is now described. As explained above, a typical matrix code specification suggests a set of colors and/or hues to be read as a certain defined color value when detected and decoded by a matrix code reader device and/or software. These suggestions can include a suggested tolerance for the suggested set of colors and/or hues. As explained above, in some matrix code specifications, such as the QR Code specification, the suggested tolerances are adaptive to the image on which the matrix code appears. As described above, the result of superimposing a matrix code on an image should be a readable matrix code, in a sense that that the resulting image contains at least a minimum set of matrix code cells, such that these cells can be detected and decoded with their correct value when the image is being scanned by a matrix code reader device and/or software. In order to make a part of an image to be detected and decoded with the correct value of a certain cell it should be (a) positioned in the right grid relative to other cells of the matrix code, and it should be (b) visually adjusted to contain color values within the suggested tolerance mentioned above. By defining the grid of the matrix code on the image, each cell of the matrix code is associated with a certain area of the image. Once the position of the matrix code on the image for which the superimposition should take place has been defined then (a) can be executed by defining a grid on the position similar to the grid of the matrix code that was chosen to be superimposed; and (b) can be executed by adjusting each area on the image that represents a certain cell according to the grid to have a group of pixels within the tolerance.

Values within the tolerances can be selected based on a visual similarity criterion which can be, for example, implemented by the processor. An example of a utilization of a visual similarity criterion for calculating a pixel value (or pixels values) for representing a certain cell in a grid of the matrix code is provided below. Further examples of a utilization of a visual similarity criterion for calculating a pixel value (or pixels values) for representing a certain cell in a grid of the matrix code is provided in PCT Patent Application No. IL2012/050410 which is hereby incorporated by reference in its entirety. FIG. 3f shows an example of such a superimposing technique as described above.

By defining the grid of the matrix code on the image, each cell of the matrix code is associated with a certain area of the image. Hence each area is associated with a certain set of pixels of the image. The portion of pixels of such a set which is needed to have color/hue values within the suggested tolerances is matrix code specification dependent. For example, some matrix code specifications, such as the QR Code specification, defines that the decoded value of a cell is a function of the average value of the pixels representing a certain cell as explained above. This means that for such matrix code specification, for certain cells, it is not necessary that all pixels will meet the conditions that are suggested or required for the average value of pixels representing the cell.

As explained above, in the process of superimposing the matrix code on an image, which is done for example in block 32, and possibly in block 34, for each set of pixels representing a certain cell of the matrix code, a portion of the set of pixels can be adjusted such that the cell could be detected and decoded properly by an appropriate scanning device as explained above. According to the presently disclosed subject matter, in the superimposition process, only the minimum number of pixels which was determined to be necessary to be adjusted within a given area, to enable proper detection and decoding by a scanning device as being compatible with a certain matrix code specification, can be selected for adjustment. In a further example, adjustment can be selected to be any number equal to or above the determined minimum number of pixels. It should be appreciated that a computer-vision technique can be used to influence the decision of which pixels within the set will be adjusted.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

An example of a computer-vision technique according to examples of the presently disclosed subject matter is now described. A perceptual similarity measure, such as the structural similarity index measure (SSIM), can be used to define which pixels in the set of pixels have more influence on human visual perceptual similarity of the image, and the said cell in particular. Then the pixels with the smallest influence may have higher priority to be the pixels that might need to be adjusted.

1. A system for superimposing a matrix code on an image comprising:
(a) a processor having an associated memory; and
(b) one or more input devices,
wherein the processor is configured to execute processes comprising:
a) superimposing a frame on the image;
b) superimposing the matrix code on the image within the frame and providing a superimposition image;
c) receiving a command to move the frame on the superimposition image, and moving the frame on the superimposition image in accordance with the command; and
d) repeating operations (i), (ii) and (iii) as required.

2. The system according to claim 1 wherein superimposing the matrix code on the image involves forming a linear combination of at least a portion of the matrix code, or part of it, and at least a portion of the image inside the frame.

3. The system according to claim 1 wherein superimposing the matrix code on the image involves making cells in the matrix code transparent or translucent.

4. The system according to claim 1 wherein the processor is further configured to edit the superimposition image.

5. The system according to claim 4 wherein the editing involves cropping the image around the frame.

6. The system according to claim 4 wherein the editing involves re-superimposing the matrix code on the image using a different method of superimposition.

7. The system according to claim 5 wherein operation (ii) of claim 1 is performed using a light run-time superimposing technique, and re-superimposing the matrix code on the image is performed using a heavy run-time technique.

8. The system according to claim 1, wherein the processor is further configured to store a result of the process in the memory.

9. The system according to claim 1, wherein the process further comprises zooming in on any part of the superimposition image.

10. The system according to claim 1, wherein the processor is further configured to execute software to position the frame on the superimposition image.

11. The system according to claim 1, wherein the processor is further configured to receive an input indicative of the superimposition being satisfactory.

12. The system according to claim 11, wherein the input indicative of the superimposition being satisfactory is input by one or more of the input devices.

13. The process according to claim 12, wherein the command to move the frame is input to the processor using an input device that is different from the input device used to input an indication that the superimposition is satisfactory.

14. The system according to claim 1, further comprising changing the matrix code when the frame is moved on the superimposition image.

15. The system according to claim 1, wherein the processor is remotely located from the input devices.

16. The system according to claim 1, wherein superimposition of the matrix code on the image comprises altering translucent properties of the matrix code to produce a matrix code having altered translucent properties, and the processor is further configured to save in a memory the matrix code having altered translucent properties.

17. A process for superimposing a matrix code on an image comprising:
a) superimposing a frame on the image;
b) superimposing the matrix code on the image within the frame and providing a superimposition image;
c) moving the frame on the superimposition image in accordance with the command; and
d) repeating operations (a), (b) and (c) as required.

18. The process according to claim 17 wherein superimposing the matrix code on the image involves forming a linear combination of at least a portion of the matrix code, or part of it, and at least a portion of the image inside the frame.

19. The process according to claim 17 wherein superimposing the matrix code on the image involves making cells in the matrix code transparent or translucent.

20. The process according to claim 17 further comprising editing the superimposition of the matrix code and the image.

21. The process according to claim 20 wherein the editing involves cropping the image around the frame.

22. The process according to claim 20 wherein the editing involves re-superimposing the matrix code on the image using a different method of superimposition.

23. The process according to claim 21 wherein operation (c) of claim 17 is performed using a light run-time superimposing technique, and re-superimposing the matrix code on the image is performed using a heavy run-time technique.

24. The process according to claim 17, further comprising zooming in on any part of the superimposition image.

25. The process according to claim 17, wherein superimposition of the matrix code on the image comprises altering translucent properties of the matrix code to produce a matrix code having altered translucent properties, and the process further comprises saving to memory the matrix code having altered translucent properties.

26. A program storage device readable by machine, tangibly embodying a program of instructions executable by the machine to perform a method of superimposing a matrix code on an image comprising:
a) superimposing a frame on the image;
b) superimposing the matrix code on the image within the frame and providing a superimposition image;
c) moving the frame on the superimposition image in accordance with the command; and
d) repeating operations (a), (b) and (c) as required.

27. A computer program product comprising a computer useable medium having computer readable program code embodied therein of superimposing a matrix code on an image, comprising:
a) computer readable program code for causing the computer to superimpose a frame on the image;
b) computer readable program code for causing the computer to superimpose the matrix code on the image within the frame and providing a superimposition image;
c) computer readable program code for causing the computer to move the frame on the superimposition image in accordance with the command; and
d) computer readable program code for causing the computer to repeat the computer readable code (a), (b) and (c) as required.
